(19) United States
(12) Patent Application Publication
(10) Pub. No.: US 2007/0280619 A1
(43) Pub. Date: Dec. 6, 2007

(54) Multi-directional optical splice organizer

(76) Inventors: Mark E. Conner, Granite Falls, NC (US); Ronald W. Erskine JR., Granite Falls, NC (US); Kevin L. Strause, Keller, TX (US); Guadalupe Rodriguez Sanchez, Reynosa (MX); Vicente Uribe Heredia, Reynosa (MX)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/439,070

(22) Filed: May 23, 2006

(51) Int. Cl. G02B 6/00

(52) U.S. Cl. 385/135

(57) ABSTRACT

A multi-directional splice organizer for attachment to an optical fiber splice tray, the splice organizer including a base and a plurality of guide studs arranged in a predetermined pattern to form splice channels for receiving, maintaining and routing optical fibers and optical splices there through. A splice organizer that allows a splice installer to orient splices in multiple directions within the splice organizer, thus allowing flexibility in fiber optic cable, optical fiber and buffer tube entry and routing within a splice tray. A universal splice organizer that allows fiber routing from multiple directions without the need for tray flipping (e.g., rotating), while retaining splice capacity.

### BACKGROUND OF THE INVENTION

1. Field of the Invention

The present invention relates generally to apparatus and methods for maintaining optical splices, and more particularly, to a universal, multi-directional splice tray organizer operable for maintaining and organizing optical splices that allows an installer to orient splices in multiple directions, thus providing full flexibility with respect to fiber entry as well as fiber routing within a splice tray.

2. Technical Background

Optical fiber is increasingly being used within the telecommunications industry for voice, video and data transmission due to the extremely wide bandwidth and the low noise associated with optical fiber. Because of the increased use, fiber optic networks are being developed to not only provide long distance signal transmission, but also to provide fiber directly to a home, business, network connection terminal or other optical interconnection point. In this regard, fiber optic networks are being developed to deliver Fiber-to-the-Premises (FTTP), Fiber-to-the-Curb (FTTC) and Fiber-to-the-Subscriber (FTTS), referred to generically as “FTTx” networks.

Recently developed FTTx networks typically include interconnection closures at various splice locations throughout the fiber optic network. Typically, these interconnection closures include splice closures, patch closures, and the like. For example, splice closures are commonly used to house and manage the splices required to interconnect optical fibers of one or more fiber optic distribution or feeder cables to respective optical fibers of one or more fiber optic drop cables. By housing the splices within a closure, the splices are protected from environmental degradation, strain, pulling forces and other deleterious forces, thereby increasing the reliability, quality and lifespan of the splices.

In each of the different examples of FTTx applications, splice closures must be capable of accommodating and maintaining a variety of types of cables in order to establish proper interconnections. One type of splice closure utilized within FTTx networks may be mounted upon a fiber optic distribution cable and permit one or more drop cables to enter the closure while allowing at least some of the optical fibers of the distribution cable to extend uninterrupted through the splice closure. Within the closure, pre-selected optical fibers of the distribution cable are spliced or otherwise optically connected to optical fibers of the one or more drop cables, or secondary distribution cables. Other types of splice management apparatus may be housed within pedestals, cabinets or other optical and network connection terminals within an FTTx network in both indoor and outdoor, as wells as buried and aerial applications.

Splice closures provide a means for routing fiber optic cables into/out of the closure, means for routing and maintaining optical fibers within a splice tray, and means for maintaining and protecting the optical splices themselves. Typically, splice closures include one or more splice trays, coupler trays, and/or connector patch panels that facilitate in the splicing or other interconnection of respective pairs of optical fibers. For ease of reference, splice trays, coupler trays, and connector patch panels will be hereinafter referred to as “optical fiber connection trays” or simply “trays.” Each tray is typically designed to maintain a plurality of splices between respective pairs of optical fibers. Since many splice closures include a large number of splices between respective pairs of optical fibers, splice closures oftentimes include a plurality of trays, typically stacked one upon another.

The splice trays are preferably provided with at least one splice organizer to organize and help maintain the splices and splice holders. Organization is particularly important within closures including large numbers of optical splices and splice holders. Conventionally, splice trays include angled (e.g., slanted) splice organizers that while providing large splice storage capacity, often limit fiber routing in the tray in such a way that fibers to be spliced must be brought in from a particular corner of the tray due to routing orientation limitations. This results because splices may only be positioned in one direction (e.g., top left to lower right; top right to lower right). In some situations, “tray flipping” may be required. As used throughout this disclosure and as known in the art, “tray flipping” is understood to mean rotating the tray about 180 degrees to facilitate routing in opposite directions to accommodate cable and buffer tube input options, limited buffer tube slack and express fiber management. The use of tray flipping can, and oftentimes does, lead to confusion and incorrect routing of the optical fibers through the splice tray by field technicians. A disadvantageous result is sharp bends of the optical fibers and associated undesirable attenuation of the fibers. This problem is especially acute in (but not limited to) FTTx applications wherein optical fibers of a distribution cable are being spliced and routed to serve subscribers. Specifically, the direction at which a cable enters a splice closure typically determines how the cables and fibers are to be routed to and within the tray.

As optical networks continue to expand, the demand increases for more efficient ways of readily organizing and maintaining optical fibers and splices within the networks. While conventional splice trays and splice organizers are adequate at performing most functions, a demand always exists for new apparatus and methods that improve the ease, efficiency, capability and routing possibilities of an increasing number of optical fibers and interconnection points. Accordingly, and in view of the shortcomings associated with current apparatus and methods, a need exists for a universal, multi-directional splice organizer compatible with any known splice tray that improves the efficiency of routing optical fibers, as well as maintaining and managing splices within network enclosures. A desired splice tray organizer should be constructed such that the previous requirement for tray flipping (e.g., rotating) the splice tray to accommodate routing in a desired direction is eliminated. In addition, a need exists for a splice tray organizer that allows splices and splice holders to be positioned on the splice tray or other enclosure structure in either a top left to lower right or top right to lower left configuration, without reducing splice holding capacity. Such a splice tray organizer should permit universal cable routing in terminals and closures regardless of which side represents the Central Office (service provider) signal side of the terminal.

### SUMMARY OF THE INVENTION

In one aspect, the present invention is directed to a universal optical splice organizer that allows a splice installer to orient optical splices in multiple directions, thus allowing flexibility with respect to cable/fiber entry as well as routing within a splice tray. In another aspect, the present invention is directed to a bi-directional splice tray organizer that allows optical splices to be routed to the splice organizer from either end of the splice organizer, thereby relaxing the direction of cable routing to a splice tray. The multi-directional splice organizer includes a plurality of splice guides for routing optical fibers and maintaining splice holders within channels defined by the arrangement of the splice guides of the organizer. The splice organizer of the present invention provides greater flexibility in fiber routing without reducing splice carrying capacity. The splice organizer of the present invention is universal in that it may be installed onto any known splice tray, optical connection terminal or other known structure for routing and retaining optical splices.

In another aspect, the present invention is directed to a splice enclosure for optical fibers and fiber optical cable, more particularly a splice tray generally comprising a base, a number of fiber optic storage means associated with the base and a splice organizer attached to the base. Specifically, the present invention provides a splice tray having a multi-directional splice organizer operable for receiving, splicing and routing optical fibers in any of multiple directions along a splice tray while avoiding violations of the minimum bend radius of the optical fibers. The multi-directional splice tray organizer preferably includes a generally flat, rectangular platform having a plurality of splice guides located thereon in a staggered configuration or pattern. Preferably, each splice guide includes a generally cylindrically shaped stud extending from the platform and a lobe located at the distal end. More preferably, each splice stud includes a pair of fins located on the lateral sides thereof. Each fin preferably includes a groove operable for receiving and routing spliced optical fibers. Further, in preferred embodiments, the staggered configuration of the splice guides form a plurality of splice channels through which optical fibers can be routed and retained.

Additional features and advantages of the invention are set forth in the detailed description which follows and will be readily apparent to those skilled in the art from that description, or will be readily recognized by practicing the invention as described in the detailed description, the drawings and the appended claims.

It is to be understood that both the foregoing general description and the following detailed description present exemplary embodiments of the invention as well as certain preferred embodiments. As such, the detailed description is intended to provide an overview or framework for understanding the nature and character of the invention as recited in the appended claims. The accompanying drawings are included to provide a further understanding of the invention, and are incorporated into and constitute a part of this specification. The drawings illustrate various preferred embodiments of the invention, and together with the detailed description, serve to explain the principles and operations thereof. Additionally, the drawings and descriptions are meant to be merely illustrative, and are not intended to limit the scope of the claims in any manner.

### BRIEF DESCRIPTION OF THE DRAWINGS

FIG. 1 is a perspective view of a splice organizer constructed in accordance with an exemplary embodiment of the present invention;

FIG. 2 is a perspective view of a portion of the splice organizer of FIG. 1 constructed in accordance with an exemplary embodiment of the present invention;

FIG. 3 is a partial plan view of the splice organizer of FIG. 1 showing the splice channel directions constructed in accordance with an exemplary embodiment of the present invention;

FIG. 4 is exploded view of a splice stud of the splice organizer of FIG. 1 constructed in accordance with the present invention; and

FIG. 5 is a plan view of an exemplary splice tray housing of the splice organizer of FIG. 1 constructed in accordance with the present invention and illustrating a method of routing and splicing optical fibers within, for example, a closure.

### DETAILED DESCRIPTION OF THE PREFERRED EMBODIMENTS

Reference will now be made in greater detail to various exemplary embodiments of the invention, preferred embodiments of which are illustrated in the accompanying drawings. Whenever possible, the same reference numerals will be used throughout the drawings to refer to the same or like parts. A multi-directional splice organizer operable for retaining and routing spliced optical fibers is shown herein for use with an SCF-ST type splice tray of the type available from Corning Cable Systems LLC of Hickory, N.C., merely for purposes of convenience. It should be understood, however, that the splice organizer disclosed herein may be applied to any optical fiber connection tray or other structure for routing and retaining optical splices. Accordingly, the invention should not be construed as being limited in any manner by the particular example of a splice organizer being attached to a splice tray shown and described herein.

In addition, it will be understood by those skilled in the art that the splice organizer of the present invention is operable for receiving a variety of different types of optical fibers and fiber optic cables, and for organizing optical splices between various types of optical fibers, such as loose tube optical fibers, tight buffered optical fibers and optical fiber ribbons. As such, the term “optical fiber” as used herein is intended to include all types of optical fibers and fiber optic cables, including loose tube optical fibers and cables and tight buffered optical fibers and cables, as well as optical fibers in the form of a multi-fiber ribbon, individual optical fibers, or any other subunit of a fiber optic cable. Additionally, the optical fibers and cables may have various diameters including, but not limited to diameters of about 250 micron, 500 micron, 900 micron, 2 mm and 3 mm. Further, the present invention is useful for both single-fiber and/or optical fiber ribbon heat shrink fusion splices.

The present invention is directed to a universal optical splice organizer that allows a splice installer to orient optical splices in multiple directions, thus allowing flexibility with respect to cable/fiber entry as well as routing within a splice tray, thereby relaxing routing direction requirements. As shown throughout the figures, the multi-directional splice organizer includes a plurality of splice guides for routing optical fibers and cables, and for maintaining optical splices within channels defined by the arrangement of the splice guides of the organizer. The splice organizer of the present invention provides greater flexibility in fiber routing without reducing splice carrying capacity. The splice organizer of the present invention is universal in that it may be installed onto any splice tray or connection terminal structure now known or hereafter devised. Although not shown, the splice organizer structure permits optical splices to be overlaid within the splice organizer routing channels. Further, in preferred embodiments, the splice organizer is manufactured from plastic or other suitable polymers using a low cost molding process.

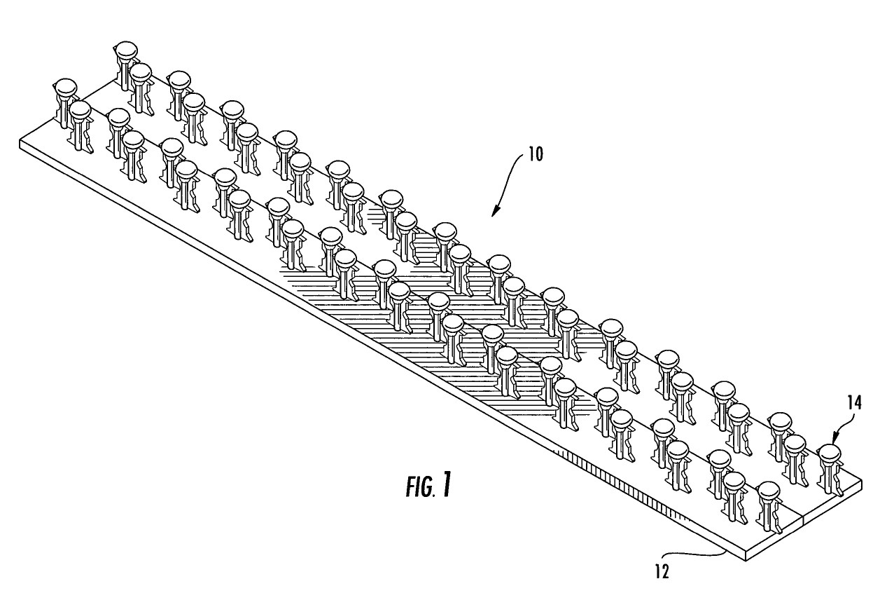

Referring now to the drawings, an enclosure for optical fibers and fiber optical cables is shown. More particularly, a splice tray generally comprising a base, a number of fiber optic storage means associated with the base and a splice organizer attached to the base is shown. As best shown in FIGS. 1-4, an exemplary embodiment of a splice organizer 10 constructed in accordance with present invention is illustrated. The splice organizer 10 is operable for maintaining and routing spliced optical fibers (and/or cables) in either of two directions along a splice tray while avoiding violations of the minimum bend radius of the optical fibers.

The splice organizer 10 is also operable for installation in any known splice tray or optical fiber connection tray and preferably includes a generally flat, rectangular platform 12 having a plurality of appropriately spaced splice guides 14 located thereon. The splice guides 14 are preferably disposed and arranged upon the platform 12 in a staggered configuration or pattern so as to permit multi-directional routing of spliced optical fibers. It will be understood by those skilled in the art that the pattern of the splice guides 14 depicted in the drawings is only representative and not limiting. In all preferred embodiments, the splice guide pattern is predetermined and can be modified to accommodate any number or orientation of optical fibers resulting in optimal versatility. As best shown in FIG. 4, each splice guide 14 preferably includes a generally cylindrically shaped stud 16 extending outwardly from the platform 12 and a lobe 20 located at the distal end of the stud 16. In other exemplary embodiments, the stud 16 may comprise a generally diamond-shaped block. It will be appreciated by those skilled in the art that any suitable shape of the stud 16 may be employed wherein the routing and retention of optical fibers is performed without violating the minimum bend radius of the optical fibers.

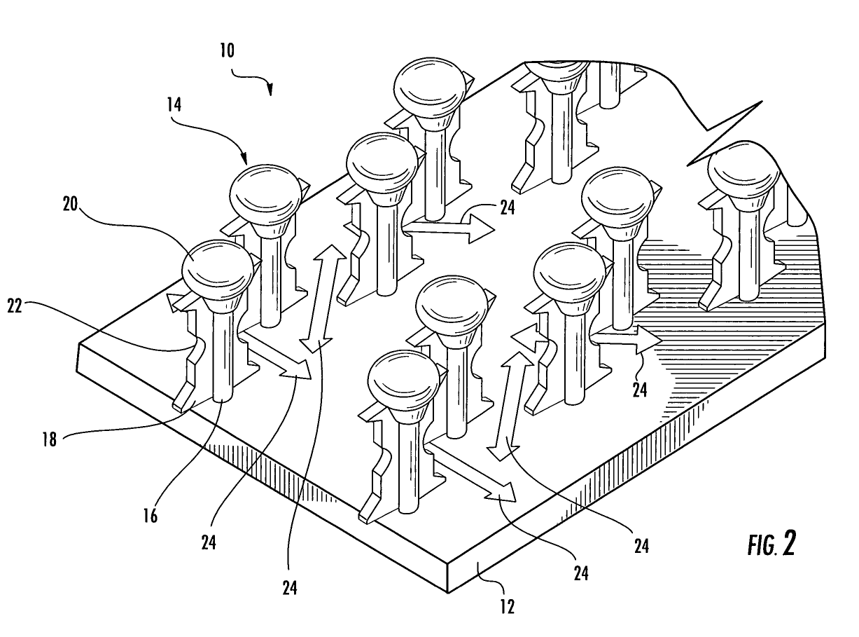

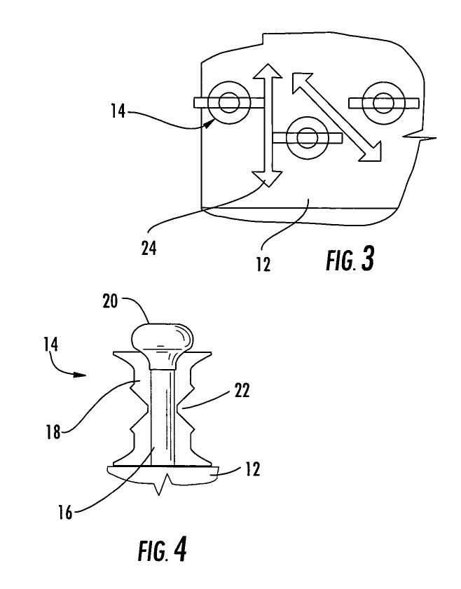

Further, in preferred embodiments, the stud 16 includes a pair of fins 18 located on the periphery thereof. The fins 18 are preferably positioned such that they are on opposed sides of the periphery of the stud 16. Each fin 18 preferably includes at least one groove 22 operable for receiving and routing at least one optical fiber. In other preferred embodiments, each fin 18 may include multiple grooves for receiving multiple optical fibers forming an overlay arrangement. Further, in preferred embodiments, the staggered configuration or pattern of the splice guides 14 is arranged such that each splice guide 14 cooperates with the surrounding splice guides to form a plurality of splice channels 24 through which optical fibers can be routed and retained. As best shown in FIGS. 2-3, the splice channels 24 permit optical fibers to be routed through the splice organizer 10 in multiple directions.

By using the multi-directional splice organizer 10 of the present invention, the need for “tray flipping” or rotating the splice tray to accommodate routing in a desired direction is eliminated. Advantageously, the present invention allows splices to be positioned in the splice tray in either a top left to lower right or top right to lower left configuration, without reducing the splice capacity. As a result thereof, fiber optic cable and buffer tube routing in terminals and closures can be universal, regardless of which side represents the Central Office (service provider) signal side of the terminal, because fiber direction is managed in the splice tray via the splice organizer 10. As illustrated, the splice organizer 10 can accommodate only a few, or many fibers, either in a tight buffered or in a loose tube configuration. It is further evident that a single or multiple cables having a plurality of fibers can be brought into the splice tray, terminated, and then spliced to optical fibers in a cable like configuration or of a different configuration. In exemplary embodiments, splices can be broken and reformed at will, there being plenty of room inside the splice tray to store excess lengths of fiber or cable for just such purpose. Preferably, the interior of the splice tray to which the splice organizer is affixed is easily accessible. Different sizes of fibers and tubes and mechanical splicing devices can be easily accommodated in the grooves 22 and channels 24 shown. The dimensions of the grooves 22 and channels 24 are such that the different optical fiber elements designed to fit therein are snugly grasped by the sidewalls forming these grooves in such a manner that the item so inserted can be easily inserted and removed.

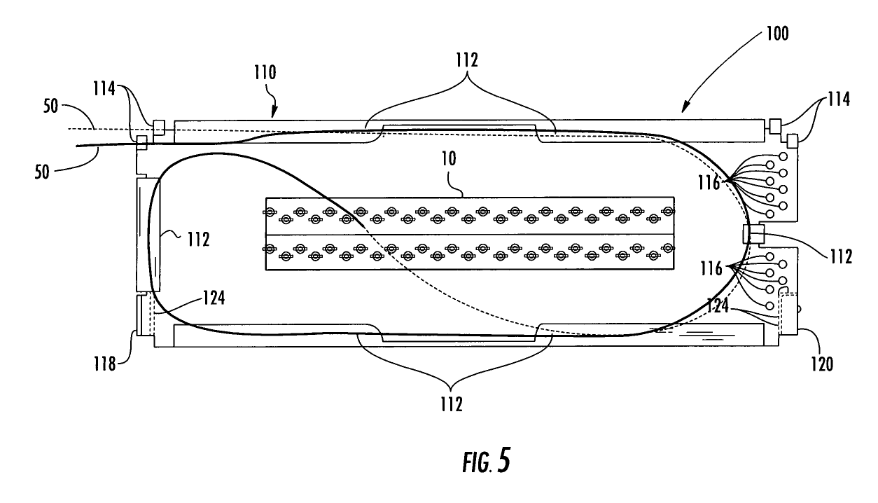

Referring now to FIG. 5, and for convenience of description only, a conventional field-installable fiber optic splice tray 100 is illustrated. By way of example, the splice tray 100 shown in FIG. 5 is a field-installable SCF-ST splice tray operable for use with aerial terminals of the type developed by and available from Corning Cable Systems LLC. However, the apparatus and methods described herein are applicable to any known splice tray or optical fiber connection tray wherein splice terminations are performed and housed. Such spliced terminations may be housed in any conventional terminal, such as Network Interface Devices (NIDs), pedestals and aerial closures. As shown, the splice tray 100 may include a generally flat tray-like base 110, a fiber storage means 112, the splice organizer 10 mounted to the tray-like base 110 and defining the plurality of splice channels 24 for respectively receiving optical fiber splices, and a removable cover (not shown) for generally closing the tray-like base 110 to protect the splices carried by the splice organizer 10. Closing and reopening of the splice tray 100 is facilitated by longitudinally extending and curved lips of the cover that snap over the longitudinally extending and curved optical fiber storage means 112 of the tray-like base 110. It will be understood by those skilled in the art that the splice organizer 10 may be attached to the base 110 in any convenient location. Further, the splice organizer 10 may be attached to the base 110 of the splice tray 100 by any suitable mounting means including adhesives and/or other mechanical means.

The tray-like base 110 preferably includes tabs 114 at its opposite ends. The tabs 114 are designed for being crimped around buffer tubes 50 that enter the splice tray 100. The tray-like base 110 also defines multiple apertures 116, each of which is operable for receiving a conventional cable tie (not shown), or the like, that holds buffer tubes 50 entering the splice tray 100. The tray-like base 110 further includes a front wall 120 that partially occludes a front opening to the interior of the splice tray 100. The tray-like base 110 further includes a lower rear wall 118 and an upper rear wall that together partially occlude a rear opening to the interior of the splice tray 100. As illustrated by broken lines, in accordance with an alternative embodiment of the present invention, the tray-like base 100 further includes supplemental walls 124 that respectively cooperate with the front wall 120 and the lower rear wall 118, and other walls of the splice tray 100, to define additional protection to the buffer tubes 50 contained in the splice tray 100.

In operation, optical fiber 50, either per se or in the tight buffered state may be brought into and maintained within the splice organizer 10. Alternatively, the splice organizer 10 may accommodate a mechanical splicing means which is a well known device that may be composed of plastic, glass or metal designed to align the optical fibers of cables into alignment so they abut one another to form a light transmission path. When such an alignment has been accomplished, the splice can be left per se or it can be encapsulated in some form of plastic, such as a splice holder well known in the art. In addition to plastic, glass or metal mechanical splicing means, one may join two abutting optical fibers outside of the tray 100 using a commonly known fusion splice, and then place the spliced optical fibers into a splice holder and the splice holder into a splice organizer 10. An encapsulate of a curable plastic (for example a silicone elastomer) may also be used to encapsulate the fused optical fibers by pouring the encapsulate onto the organizer 10 and allowing the plastic to cure.

It will be apparent to those skilled in the art that innumerable modifications and variations can be made to the exemplary embodiments of the apparatus and methods of the invention shown and described herein without departing from the spirit and scope of the invention. Thus, it is intended that the present invention cover all conceivable modifications and variations of this invention, provided those alternative embodiments fall within the scope of the appended claims and their equivalents.

What is claimed is:

1. An optical splice organizer, comprising:
a base portion; and
a plurality of guide studs affixed to and protruding from the base portion, wherein the plurality of guide studs are arranged in a pattern forming a plurality of splice channels operable for routing and maintaining optical splices within the splice channels.

2. The splice organizer according to claim 1, wherein the pattern of guide studs allows a field installer to orient the optical splices in multiple directions within the splice organizer.

3. The splice organizer according to claim 1, wherein the splice organizer is affixed to a splice tray defining a plurality of corners.

4. The splice organizer according to claim 3, wherein the pattern of guide studs allows one or more optical fibers or optical splices to be routed into the splice organizer from any of the plurality of corners of the splice tray.

5. The splice organizer according to claim 1, wherein the guide studs are diamond-shaped for retaining at least one of the optical splices.

6. The splice organizer according to claim 1, wherein the guide studs include a generally cylindrical protrusion extending outwardly from a base portion, a lobe disposed about the distal end of the protrusion, one or more guide fins positioned on opposed sides of the protrusion, and at least one groove formed within each guide fin operable for maintaining at least one of the optical splices.

7. The splice organizer according to claim 1, wherein the pattern of guide studs permits splices to be positioned within the splice organizer in either a top left to lower right or top right to lower left configuration.

8. An optical splice management apparatus, comprising:
an optical splice tray defining a surface for affixing a splice organizer thereto; and
a splice organizer affixed to the optical splice tray comprising a base portion and a plurality of splice guides affixed to and protruding outwardly from the base portion, wherein the plurality of splice guides are arranged in a pattern forming a plurality of splice channels operable for routing and maintaining optical splices within the splice channels.

9. The optical splice management apparatus according to claim 8, wherein the optical splices are able to be oriented in multiple directions within the splice organizer.

10. The optical splice management apparatus according to claim 8, wherein each of the plurality of splice guides includes a stud extending outwardly, a lobe disposed about the distal end of the stud, one or more guide fins positioned on opposed sides of the stud, and at least one groove operable for retaining at least one of the optical splices.

11. The optical splice management apparatus according to claim 8, wherein the plurality of splice guides are arranged to permit fiber entry from either end of the splice organizer.

12. The optical splice management apparatus according to claim 8, wherein the splice tray is installed within a splice closure or optical connection terminal.

13. The optical splice management apparatus according to claim 8, wherein the optical splices are overlaid within the splice organizer.

14. A splice organizer for maintaining and organizing optical splices, comprising:
a generally rectangular flat platform; and
a plurality of guide studs mounted in a predetermined pattern on a surface of the platform forming a plurality of splice channels operable for routing optical fibers there through without violating a minimum bend radius of the optical fibers,
wherein the apparatus is mounted to a splice tray or connector patch.

15. The splice organizer according to claim 14, wherein each of the plurality of guide studs comprises means for retaining at least one of the optical splices.

16. The splice organizer according to claim 14, wherein optical fiber and splice arrangement within the splice organizer is multi-directional.

17. The splice organizer according to claim 14, wherein each of the guide studs includes a generally cylindrical protrusion extending outwardly from the platform, a lobe disposed about the distal end of the protrusion, one or more guide fins positioned on opposed sides of the protrusion, and at least one groove formed within each guide fin operable for retaining at least one of the optical splices therein.
